(19) United States
(12) Patent Application Publication
(10) Pub. No.: US 2024/0425212 A1
(43) Pub. Date: Dec. 26, 2024

(54) Motor Mounting to a Multi-rotor Aircraft Frame

(71) Applicant: Martin Meszaros, Beaverton, OR (US)

(72) Inventor: Martin Meszaros, Beaverton, OR (US)

(21) Appl. No.: 18/213,835

(22) Filed: Jun. 24, 2023

(51) Int. Cl. B64D 27/26; F16F 15/08

(52) U.S. Cl. CPC B64U 30/29; F16F 15/08; B64U 50/19

(57) ABSTRACT

A novel multi-rotor aircraft motor mounting arm assembly used to improve stiffness, durability, strength, and thrust efficiency of the motor mount arm while providing harmonic isolation of motor and prop vibrations.

### BACKGROUND

The various aspects discussed herein relate to multirotor aircrafts.

Current multirotor aircraft arm and motor mounting designs negatively affect the aircraft's performance.

Consequently, there is a need in the art for an improved aircraft arm and motor mounting design.

### SUMMARY OF THE INVENTION

The present invention relates to a vertical plate mounting system that is used to position a motor on a multi-rotor aircraft's frame. The system uses two vertically oriented flat plate arms to triangulate and position the aircraft's motor relative to the frame's lateral and longitudinal axis.

The vertical plates feature two or more slots that are used to locate the motor relative to the frame's vertical axis. The invention allows for adjustable mounting stiffness through the use of damping grommets (FIG. 1, #3) placed between the frame and plate slot mounting interface. This grommet is harmonically tunable by varying geometry and durometer hardness.

By tuning the arms to main body rigidity, harmonic oscillations caused by the motor can be reduced, isolated from the main body, or eliminated entirely. Additionally, varying vertical plate width allows the independent tuning of arm torsional rigidity coaxial to the arm axis without impacting vehicle thrust or planar rigidity relative to the top plane of the aircraft.

### BRIEF DESCRIPTION OF DRAWINGS

FIG. 1: View of multirotor aircraft frame (#1), vertical motor mount arm plates (#2), and arm isolation grommets (#3).

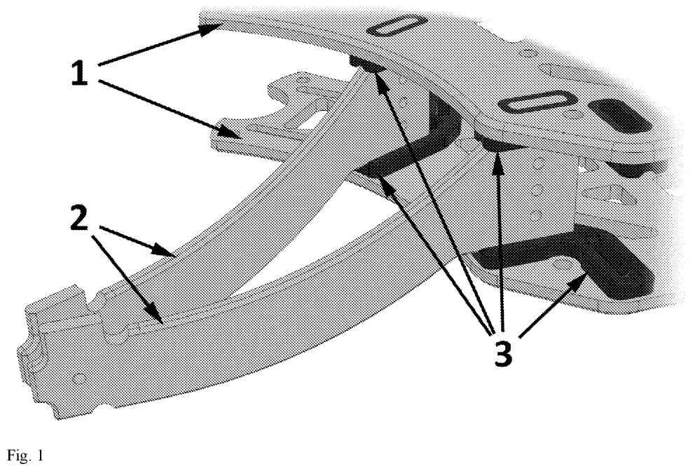

FIG. 2: A single mounting arm (#2) and a pair of isolation grommets for that arm (#3).

FIG. 3: Two motor mount arm plates (#2) in relation to the aircraft motor (4). The locating slots of the motor mount arm plates are visible. The motor mount to arm plates assembly is not shown.

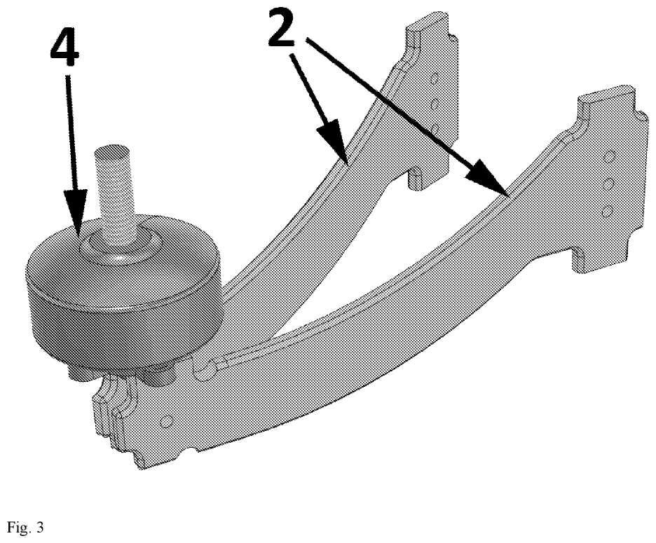

FIG. 4: The top-down view of the aircraft frame (#1), motor mount arm plates (#2), and motor (#4). This image demonstrates the arm cross section relative to the direction of thrust.

### DETAILED DESCRIPTION

The conventional arm design in multirotor aircraft utilizes a single arm rigid mounted to the aircraft chassis to attach the motor. Since a single arm is responsible for locating each motor, a rigid mounting is necessary to avoid torsional oscillation along the axis of the arm. Furthermore, the ideally round motor arm required for stiffness and durability directly impacts motor net thrust output facilitating a trade-off between weight, stiffness, and performance.

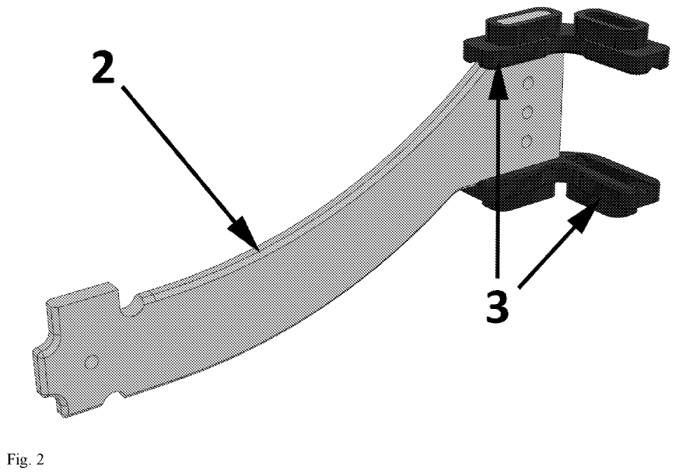

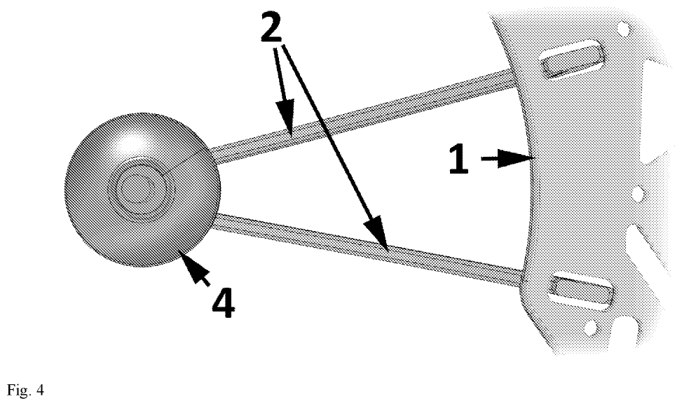

The new vertical plate mounting system is a significant improvement over existing mounting systems. The use of two flat plate arms provides a triangulated positioning of the motor, ensuring better torsional stiffness relative to the arm axis while maintaining a minimal face-on cross section relative to the direction of thrust (FIG. 4, #2). Durability and motor harmonic isolation is provided by the damping grommets used as an interface between the arms and frame providing the ability to adjust the mounting stiffness (FIG. 2, #3).

The damping grommets serve several benefits including, but not limited to;
a. Isolation of motor vibrations which can cause difficult to filter sensor noise seen by the aircraft's flight controller.
   i. Harmonic isolation is important for optimal functioning of the body mounted flight controller's hardware and software by reducing or eliminating the need for filtering of accelerometer and gyroscope input data as part of the flight controller's PID loop.
   ii. By varying the geometry and stiffness of the grommet material, specific harmonic modes of the motor and arm assembly can be damped and thus isolated from the main chassis of the aircraft.
b. Elimination of vibration modes that contribute to degraded image quality of onboard cameras. Notably onboard cameras such as First Person View (FPV) or video cameras that utilize a rolling shutter are sensitive to specific harmonics. Tuning durometer hardness or geometry of the mounting grommets allows the elimination of such primary and secondary harmonics.
c. Improving crash durability by providing compliance between the motor arms and chassis.
   i. Historically, arm durability was directly proportional to arm thickness. The damping grommets allow for significantly less arm material while maintaining crash compliance.
   ii. Failure mode and yield characteristics of the motor arm can be isolated to the grommet failure to prevent motor arm damage.
d. The multi-plate rigid arms and motor assembly is significantly stiffer than a single motor arm in the torsional and yaw axis thanks to the large geometric arm attachment footprint relative to a single arm. With the use of isolating grommets, these beneficial stiffness characteristics can be maintained while still removing the harmonic resonances indicative of high-stiffness motor arms. To put another way, damping grommets allow motor arm stiffness and motor arm harmonics to be independently tunable parameters.

1. A motor mounting to multi-rotor frame assembly comprising:
a. two or more motor arm plates orthogonal, or nearly orthogonal, to the motor's plane of rotation,
b. complementary locating features on the motor arm plates and the aircraft's body or main chassis such as, but not limited to, slots, pins, grooves, or holes between the motor arm plates and the aircraft's body or main chassis, and
c. grommets that completely or partially isolate the motor arm plates locating features from the associated locating features of the aircraft's body or main chassis
whereby the said assembly is used to attach a motor mount, and by extension the motor, to the aircraft's body or main chassis.
